(19) United States
(12) Patent Application Publication
(10) Pub. No.: US 2026/0321058 A1
(43) Pub. Date: Oct. 15, 2026

(54) PERSON SEARCH APPARATUS AND METHOD

(71) Applicants: HYUNDAI MOTOR COMPANY, Seoul (KR); Kia Corporation, Seoul (KR)

(72) Inventor: Chanyeong SON, Hwaseong-si (KR)

(21) Appl. No.: 19/404,888

(22) Filed: Dec. 1, 2025

(30) Foreign Application Priority Data
Apr. 9, 2025 (KR) 10-2025-0045981

(51) Int. Cl. G06V 40/16; G06V 10/70; G06V 40/20

(52) U.S. Cl. CPC G06V 40/172; G06V 10/70; G06V 40/161; G06V 40/171; G06V 40/25; G06V 2201/07

(57) ABSTRACT

A person search apparatus is configured to search for a person and a trajectory of the person based on appearance information of the person acquired through one or more cameras. The person search apparatus includes one or more processors and one or more memory devices storing a program code configured to, based on being executed by the one or more processors, cause the person search apparatus to perform operations. The operations include, based on an input of an image of a human acquired from the one or more cameras, outputting recognition information including an attribute of the human, storing, in a database, the recognition information and a person keyshot that is generated based on the recognition information, and in response to a request of a user, searching for a target person based on attribute information of the human and re-identification information in the database.

### CROSS-REFERENCE TO RELATED APPLICATION

This application claims priority to and the benefit of Korean Patent Application No. 10-2025-0045981, filed with the Korean Intellectual Property Office, on Apr. 9, 2025, the entire contents of which are incorporated herein by reference.

### TECHNICAL FIELD

The present disclosure relates to a person search apparatus and method, and more specifically, to a person search apparatus and method of searching for a person and a trajectory of a person using a multi-camera-based surveillance system and a mobile robot.

### BACKGROUND

A person search system may be used to find a specific person in CCTV, autonomous driving, and smart security. In some cases, the person search system can be implemented using computer vision and deep learning. For example, a search system may perform a search based on person attribute information of a person in an image taken by a single camera. In addition, the search system may not utilize person appearance information.

### SUMMARY

The present disclosure describes a person search apparatus and method capable of searching for information about the same person from multiple cameras by a primary search using attribute information acquired by a multi-camera-based surveillance system and a mobile robot and a secondary search using re-identification information.

The present disclosure also describes a person search apparatus and method of storing person information at a specific time point that is easy for a user to identify and is available to be used in a re-identification algorithm.

According to one aspect of the subject matter described in this application, a person search apparatus is configured to search for a person and a trajectory of the person based on appearance information of the person acquired through one or more cameras. The person search apparatus includes one or more processors and one or more memory devices storing a program code configured to, based on being executed by the one or more processors, cause the person search apparatus to perform operations. The operations include, based on an input of an image of a human acquired from the one or more cameras, outputting recognition information including an attribute of the human, storing, in a database, the recognition information and a person keyshot that is generated based on the recognition information, and in response to a request of a user, searching for a target person based on attribute information of the human and re-identification information in the database.

Implementations according to this aspect can include one or more of the following features. For example, outputting the recognition information can include inferring, by using an artificial intelligence model, the recognition information including at least one of a skeleton, a bounding box, a keypoint, a pose, an action, or an attribute of the human in the image. In some examples, storing the recognition information and the person keyshot can include accumulating and storing the recognition information in the database, calculating a face size score, an upper body size score, a lower body size score, and an upper body direction score, calculating a person keyshot score based on the face size score, the upper body size score, the lower body size score, and the upper body direction score, and updating a current person keyshot based on the recognition information and the person keyshot score.

In some implementations, storing the recognition information and the person keyshot further can include determining whether to store the updated current person keyshot in the database based on at least one of a frame size of the current person keyshot, a presence time of the current person keyshot, or whether the current person keyshot is present in a current camera frame. In some examples, calculating the face size score, the upper body size score, the lower body size score, and the upper body direction score can include calculating the face size score based on a coordinate distance between eyes of the human and a coordinate distance between ears of the human, calculating the upper body size score based on a coordinate distance between shoulders of the human and a coordinate distance between hips of the human, and calculating the lower body size score based on a keypoint-based knee-to-ankle coordinate distance of the human and a keypoint-based hip-to-knee coordinate distance of the human.

In some examples, calculating the person keyshot score can include calculating the person keyshot score through Equation 1,

Person keyshot score=Upper body direction score*(α*face size score+β*upper body size score+γ*lower body size score), Equation 1

here, α, β, and γ are arbitrary coefficients.

In some examples, calculating the person keyshot score through the Equation 1 can include, based on an upper body direction of the human not being oriented to a front of the human, determining the upper body direction score from an arbitrary score between 0 and 1.

In some implementations, searching for the target person can include outputting a target person keyshot for the target person from the database based on the attribute information including at least one attribute selected by the user. In some examples, searching for the target person further can include, based on the user selecting the target person keyshot that is output from the database, outputting one or more images stored during a pried including a time point at which the target person keyshot is stored. In some examples, searching for the target person further can include outputting a trajectory of the target person within a range of the one or more cameras through the re-identification information based on the target person keyshot.

According to another aspect, a person search method is performed by a computing device including a processor and a memory. The person search method includes, based on an input of an image of a human acquired from the one or more cameras, outputting recognition information including an attribute of the human, storing, in a database, the recognition information and a person keyshot that is generated based on the recognition information, and in response to a request of a user, searching for a target person based on attribute information of the human and re-identification information in the database.

Implementations according to this aspect can include one or more of the following features. For example, outputting the recognition information can include inferring, by using an artificial intelligence model, the recognition information including at least one of a skeleton, a bounding box, a keypoint, a pose, an action, or an attribute of the human in the image. In some examples, storing the recognition information and the person keyshot can include accumulating and storing the recognition information in the database, calculating a face size score, an upper body size score, a lower body size score, and an upper body direction score, calculating a person keyshot score based on the face size score, the upper body size score, the lower body size score, and the upper body direction score, and updating a current person keyshot based on the recognition information and the person keyshot score.

In some implementations, storing the recognition information and the person keyshot further can include determining whether to store the updated current person keyshot in the database based on at least one of a frame size of the current person keyshot, a presence time of the current person keyshot, or whether the current person keyshot is present in a current camera frame. In some examples, calculating the face size score, the upper body size score, the lower body size score, and the upper body direction score can include calculating the face size score based on a coordinate distance between eyes of the human and a coordinate distance between ears of the human, calculating the upper body size score based on a coordinate distance between shoulders of the human and a coordinate distance between hips of the human, and calculating the lower body size score based on a keypoint-based knee-to-ankle coordinate distance of the human and a keypoint-based hip-to-knee coordinate distance of the human.

In some examples, calculating the person keyshot score can include calculating the person keyshot score through Equation 1,

Person keyshot score=Upper body direction score*(α*face size score+β*upper body size score+γ*lower body size score), Equation 1
here, α, β, and γ are arbitrary coefficients.

In some examples, calculating the person keyshot score through the Equation 1 can include, based on an upper body direction of the human not being oriented to a front of the human, determining the upper body direction score from an arbitrary score between 0 and 1.

In some implementations, searching for the target person can include outputting a target person keyshot for the target person from the database based on the attribute information including at least one attribute selected by the user. In some examples, searching for the target person further can include, based on the user selecting the target person keyshot that is output from the database, outputting one or more images stored during a pried including a time point at which the target person keyshot is stored. In some examples, searching for the target person further can include outputting a trajectory of the target person within a range of the one or more cameras through the re-identification information based on the target person keyshot.

In some implementations, the person search apparatus and method can store a person's appearance that is available to be identified, and search for a person from all data stored in the system with only simple appearance information without an accurate face image or specific facts of the person.

In some implementations, the person search apparatus and method can reinforce functions of an intelligent security system, such as finding missing persons, through attribute information-based user search, and can be used for data analysis in the distribution industry and the like.

### BRIEF DESCRIPTION OF THE DRAWINGS

FIG. 1 is a block diagram showing an example of a person search apparatus.

FIG. 2 is a flowchart showing an example of a person search method.

FIG. 3 is a flowchart showing an example of a person keyshot update algorithm.

FIG. 4 is a flowchart showing an example of a person keyshot score calculation algorithm.

FIG. 5 is a flowchart showing an example of a face size score calculation algorithm.

FIG. 6 is a flowchart showing an example of an upper body size score calculation algorithm.

FIG. 7 is a flowchart showing an example of a lower body size score calculation algorithm.

FIG. 8 is a flowchart showing an example of an upper body direction score calculation algorithm.

FIGS. 9 and 10 are flowcharts showing examples of a person keyshot storage algorithm.

FIG. 11 is a diagram illustrating an example of a person search result.

FIG. 12 is a diagram illustrating an example of a person keyshot and a person keyshot score.

FIG. 13 is a diagram illustrating an example of a computing device.

### DETAILED DESCRIPTION

The present disclosure will be described more fully hereinafter with reference to the accompanying drawings, in which implementations of the disclosure are shown. As those skilled in the art would realize, the described implementations can be modified in various different ways, all without departing from the spirit or scope of the present disclosure. Accordingly, the drawings and description are to be regarded as illustrative in nature and not restrictive. Like reference numerals designate like elements throughout the specification.

In addition, the terms “ . . . unit”, “ . . . or”, and “ . . . module” described in the specification mean units for processing at least one function and operation and can be implemented by hardware components, circuit, software components, or combinations of software and hardware or circuit.

Furthermore, at least some of the configurations or functions of a person search apparatus and method according to the implementations described below can be implemented as programs or software, and programs or software can be stored in computer-readable media.

Hereinafter, implementations of the present disclosure will be described with reference to the drawings.

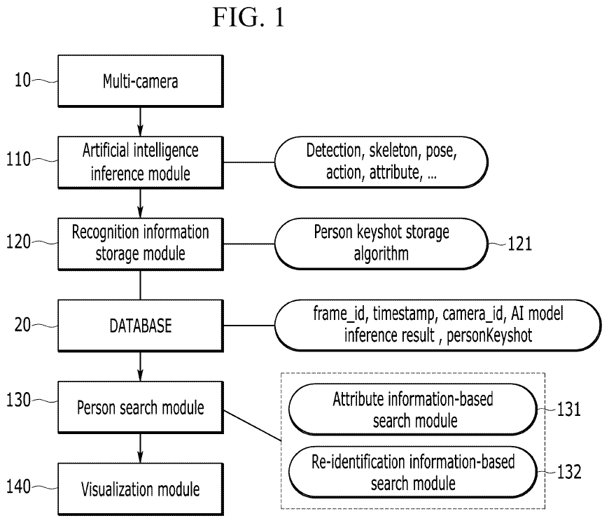

FIG. 1 is a block diagram of an example of a person search apparatus.

In some implementations, a person search apparatus 100 can execute a program code or instruction stored in one or more memory devices through one or more processors.

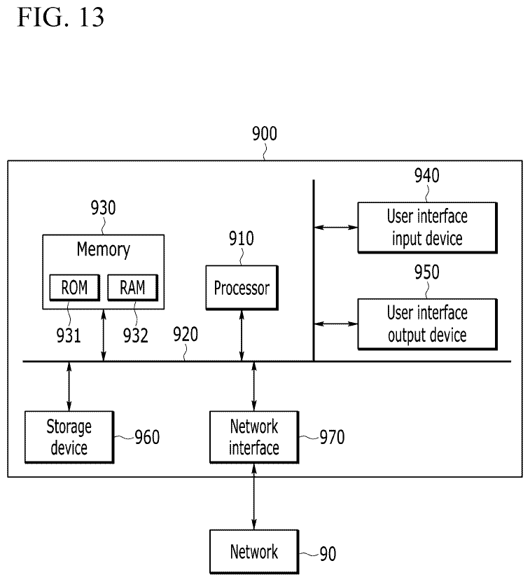

For example, the person search apparatus 100 can be implemented as a computing device 900 as described later with reference to FIG. 13. In this case, one or more processors can correspond to a processor 910 of the computing device 900, and one or more memory devices can correspond to a memory 930 of the computing device 900.

The program code or instruction can be executed by one or more processors to search for a person and a person's trajectory based on person's appearance information acquired through a multi-camera. In this specification, the term “module” is used to logically distinguish these functions performed by a program code or instruction. In some examples, the multi-camera can refer to one or more cameras.

Referring to FIG. 1, the person search apparatus 100 can include an artificial intelligence inference module 110, a recognition information storage module 120, a person search module 130, and a visualization module 140.

The artificial intelligence inference module 110 can output recognition information including human attributes by using an image acquired from the multi-camera 10 as an input.

The artificial intelligence inference module 110 can infer the recognition information including at least one of a skeleton, bounding box (bbox), keypoint, pose, action, and attribute of a person (i.e., human) in an image by using an artificial intelligence model.

The recognition information storage module 120 can store the recognition information and a person keyshot generated based on the recognition information in the database 20.

That is, the recognition information storage module 120 can store the result inferred through the artificial intelligence inference module 110 and the previously acquired image and time information together in the database 20.

The person keyshot can include images and attribute information (person attribute) at a moment to identify while a person appears in one camera.

The person keyshot can be a selected frame (image) representing a specific person in the image. That is, the person keyshot can be an image that clearly reveals the most important characteristic or attribute of a specific (or target) person. In some examples, the most important characteristics can be predetermined. In some examples, the most important characteristics can vary based on the target person.

The database 20 can store RGB images, photographing time (time stamp), camera ID, person keyshot, artificial intelligence model-based recognition information, and attribute information.

Artificial intelligence model-based recognition information includes bbox coordinates, posture information, skeleton coordinates, action information, and the like, and the attribute information (person attribute) can include gender, upper and lower clothes length and color, shoe color and type, hat wearing, bag wearing, and the like.

The recognition information storage module 120 can include a person keyshot storage algorithm 121.

The recognition information storage module 120 can cumulatively store recognition information.

The recognition information storage module 120 can calculate each of a face size score, an upper body size score, a lower body size score, and an upper body direction score.

The recognition information storage module 120 can calculate a person keyshot score based on the calculated face size score, upper body size score, lower body size score, and upper body direction score.

The recognition information storage module 120 can update the current person keyshot based on the current state based on the recognition information and the calculated person keyshot score.

The recognition information storage module 120 can determine whether to store the person keyshot in the database 20 in consideration of at least one of the frame size and presence time of the current person keyshot, and presence of the person keyshot in the current camera frame with respect to the updated current person keyshot.

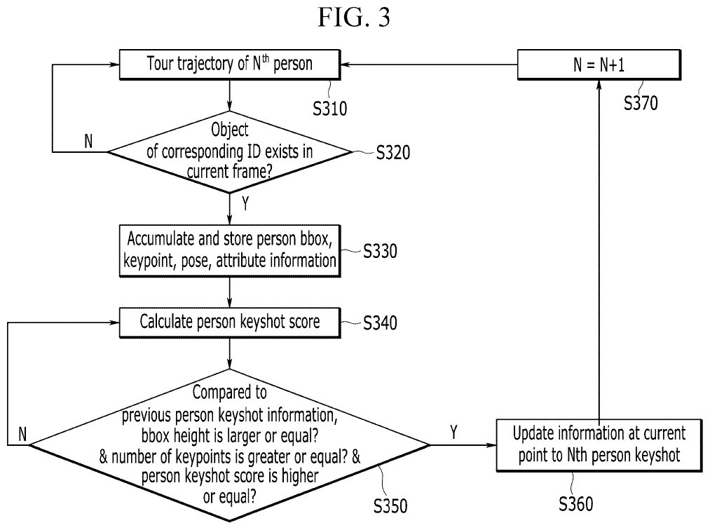

The person keyshot storage algorithm 121 will be described in detail with reference to FIGS. 3 to 10.

The person search module 130 can search for a specific person based on the person attribute information and the re-identification information (person Re-Id) from the database 20 according to the user's request.

The person search module 130 can include an attribute information-based search module 131 and a re-identification information-based search module 132.

The attribute information-based search module 131 performs a search based on the attribute information in the database 20.

That is, the attribute information-based search module 131 can extract an object in a multi-camera that matches the attribute information selected by the user through the attribute information search (e.g., person attribute recognition, PAR).

The re-identification information-based search module 132 performs a search based on the re-identification information ReID in the database 20.

That is, the re-identification information-based search module 132 can extract a trajectory in a multi-camera through re-identification information search based on a trajectory in a single camera of the selected object (person).

The visualization module 140 can output a snapshot, an image sequence, an object trajectory, and the like of the search result.

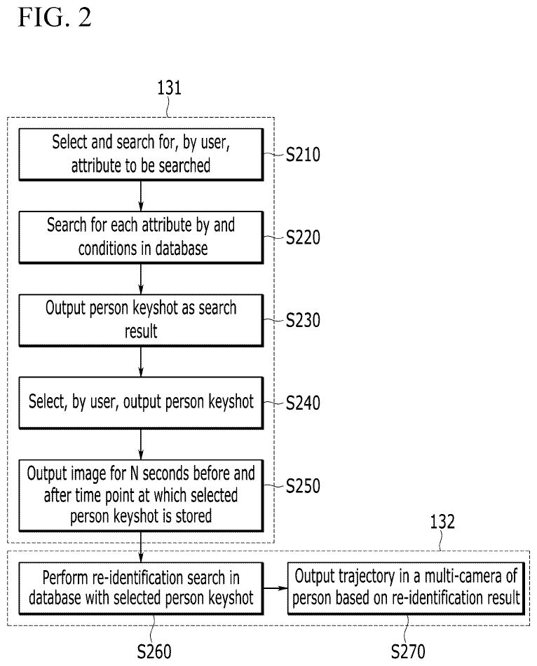

FIG. 2 is a flowchart of an example of a person search method. The person search method of FIG. 2 can be performed by the person search apparatus 100 of FIG. 1.

For example, operations S210 to S250 can be performed through the attribute information-based search module 131, and operations S260 and S270 can be performed through the re-identification information-based search module 132.

In FIG. 2, when the user selects and searches for an attribute to be searched (operation S210), the attribute information-based search module 131 can search for each attribute by and conditions in the database 20 (see FIG. 1) (operation S220).

The attribute information-based search module 131 can output a person keyshot corresponding to the attribute selected as the search result (operation S230).

When the user selects the output person keyshot (operation S240), the attribute information-based search module 131 can output an image for N seconds before and after the time point at which the selected person keyshot is stored (operation S250).

The re-identification information-based search module 132 can perform re-identification in the database 20 with the selected person keyshot (operation S260).

The re-identification information-based search module 132 can output a trajectory in a multi-camera 10 (see FIG. 1) of a person based on the re-identification result (operation S270).

That is, the person search apparatus 100 can output a specific person keyshot for a specific person from the database 20 based on attribute information including at least one attribute selected by the user.

When the user selects the specific person keyshot output by the user, the person search apparatus 100 can output an image for a specific time including a time point at which the specific person keyshot is stored.

The person search apparatus 100 can output a trajectory in a multi-camera of a specific person through re-identification based on a specific person keyshot.

FIG. 3 is a flowchart of an example of a person keyshot update algorithm.

In FIG. 3, the person search apparatus 100 can tour the trajectory of the N^{th} person among a plurality of people (operation S310).

That is, the person search apparatus 100 can analyze data while tracking a trajectory of a specific person (N^{th} person).

Here, the trajectory data is owned by each person appearing in the image, and
may include information accumulated during the existence time of the specific person, camera number (tracking ID) in which a person appears, AI inference module information (bbox, pose, keypoint, attributes, action, etc.), initial existence time, presence in the current image, and person keyshot.

The person search apparatus 100 can determine whether an object of a corresponding ID exists in the current frame (operation S320).

When it is determined that a specific person of the corresponding ID exists in the current frame, the person search apparatus 100 can cumulatively store the bbox, key point, pose, attribute information of the corresponding person, and the like.

The person search apparatus 100 can calculate a person keyshot score for the specific person (operation S340).

The person search apparatus 100 can determine whether the current bbox height is greater or equal to, whether the number of keypoints is greater or equal to, and whether the current person keyshot score is higher or equal compared to the previous person keyshot information based on the recognition information.

For example, when the number of key points of one person is 17, the number of key points can change while appearing in the image. When only the upper body of the person appears in the image, the number of key points can be less than 17.

The person search apparatus 100 can update the information at the current time point to the N^{th} person keyshot for the N^{th} person when the current bbox is larger, the number of key points is larger, and the person keyshot score is higher compared to the previous person keyshot information (operation S360).

The person search apparatus 100 can update the N^{th} person keyshot based on at least one of bbox information, keypoint number information, and person keyshot score information at the current time point.

The person search apparatus 100 can update the cropped image included in the frame of the current time point, the number of bounding boxes and key points, and the current person keyshot score.

The person keyshot update algorithm is an algorithm for optimal snapshot storage based on person keypoint information.

The person search apparatus 100 can update the person keyshot based on the bbox size even when there is no keypoint information.

The person search apparatus 100 can perform a person keyshot update algorithm for the (N+1)^{th} person after the update of the N^{th} person keyshot (operation S370).

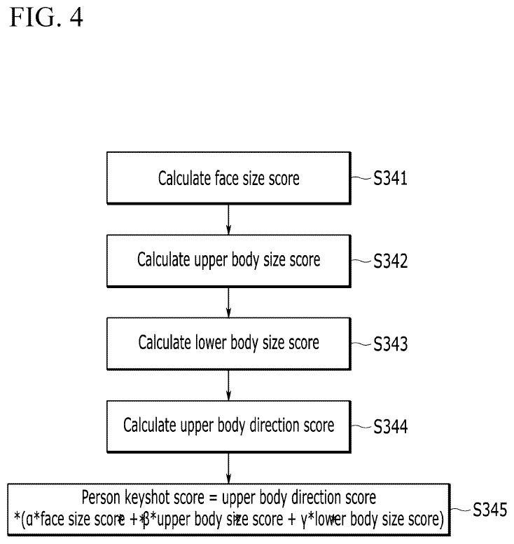

FIG. 4 is a flowchart of an example of the person keyshot score calculation algorithm.

In FIG. 4, the person search apparatus 100 can calculate a face size (face direction) score, an upper body size score, a lower body size score, and an upper body direction score, and calculate a person keyshot score based on the calculated face size score, upper body size score, lower body size score, and upper body direction score.

That is, the person search apparatus 100 can calculate the face size score based on a coordinate distance between both eyes and a coordinate distance between both ears (operation S341).

The person search apparatus 100 can calculate the upper body size score based on a coordinate distance between both shoulders and a coordinate distance between both hips (operation S342).

The person search apparatus 100 can calculate the lower body size score based on a key point-based knee-to-ankle coordinate distance and a key point-based hip-to-knee coordinate distance (operation S343).

The person search apparatus 100 can calculate the upper body direction score based on whether the person is facing the front (operation S344).

The person search apparatus 100 can calculate the person keyshot score through Equation 1 (operation S345).

Person keyshot score=Upper body direction score*(α*face size score+β*upper body size score+γ*lower body size score) Equation 1

Here, α, β, and γ can each be a number greater than 1.0. For example, α can be 5.0, β can be 1.5, and γ can be 2.0.

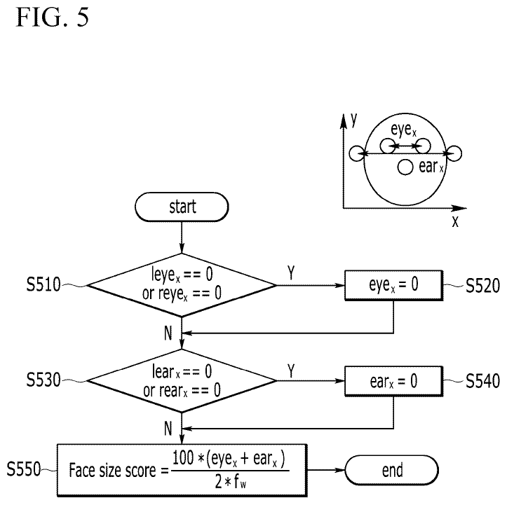

FIG. 5 is a flowchart of an example of a face size score calculation algorithm.

The person search apparatus 100 can calculate a face size score based on a coordinate distance between both eyes and a coordinate distance between both ears.

In FIG. 5, eyeₓ is the x-coordinate distance between both eyes, eyeₓ=abs (leyeₓ−reyeₓ), where leyeₓ is the x-coordinate of the left eye and reyeₓ is the x-coordinate of the right eye.
earₓ is the x-coordinate distance between both ears, earₓ=abs(learₓ−rearₓ), learₓ is the x-coordinate of the left ear, and rearₓ is the x-coordinate of the right ear.
f_{w} is the width of the entire frame, and fₕ is the height of the entire frame.

The person search apparatus 100 can determine whether the x-coordinate of the left eye or the x-coordinate of the right eye is 0 (operation S510).

The person search apparatus 100 determines that the distance of the x-coordinate between both eyes is 0 when any one of the x-coordinate of the left eye and the x-coordinate of the right eye is 0 (operation S520).

When the x-coordinate of the left eye and the x-coordinate of the right eye are not 0, the person search apparatus 100 can determine whether the x-coordinate of the left ear or the x-coordinate of the right ear is 0 (operation S530).

When any one of the x-coordinate of the left ear and the x-coordinate of the right ear is 0, the person search apparatus 100 determines that the x-coordinate distance between both ears is 0 (operation S540).

When both the x-coordinate of the left ear and the x-coordinate of the right ear are not 0, the person search apparatus 100 can calculate a face size score (operation S550).

The person search apparatus 100 can calculate a face size score through Equation 2.

$$\frac{100 * ( {eye}_{x} + {ear}_{x} )}{2 * {f}_{w}} \qquad [ Equation2 ]$$

Here, eyeₓ is the x-coordinate distance between both eyes, earₓ is the x-coordinate distance between both ears, and f_{w} is the width of the entire frame.

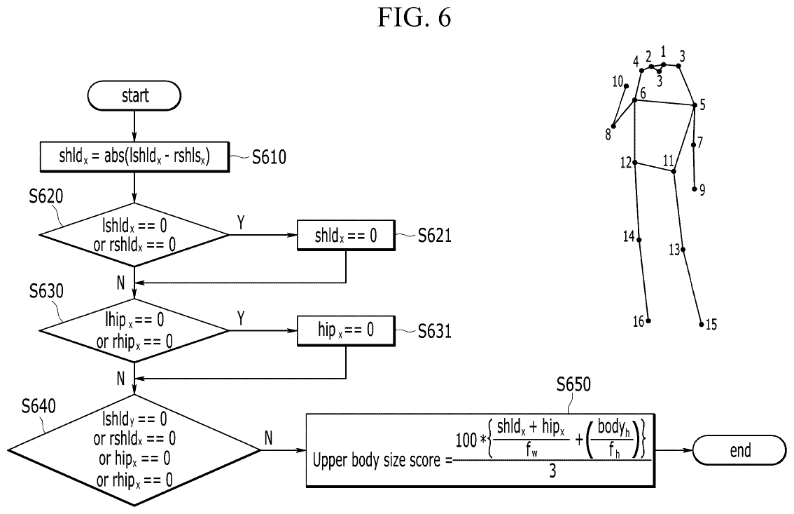

FIG. 6 is a flowchart of an example of an upper body size score calculation algorithm. The person search apparatus 100 can calculate an upper body size score based on a coordinate distance between both shoulders and a coordinate distance between both hips.

In FIG. 6, bodyₕ is the height of the upper body of a person, and can be calculated through Equation 3.

$${body}_{h} = abs ( \frac{{lshld}_{y} + {rshld}_{y}}{2} - \frac{{lhip}_{y} + {rhip}_{y}}{2} ) \qquad [ Equation3 ]$$

shldₓ is the distance of the x-coordinate between both shoulders, and shldₓ=abs(lshldₓ−rshldₓ). lshldₓ is the x-coordinate of the left shoulder, and rshldₓ is the x-coordinate of the right shoulder.
shld_{y} is the y-coordinate distance between both shoulders, and shld_{y}=abs (lshld_{y}−rshld_{y}). lshld_{y} is the y-coordinate of the left shoulder, and rshld_{y} is the y-coordinate of the right shoulder.
hipₓ is the x-coordinate distance between both hips, and hipₓ=abs(lhipₓ−rhipₓ). lhipₓ is the x-coordinate of the left hip, and rhipₓ is the x-coordinate of the right hip.
hip_{y} is the y-coordinate distance between both hips, and hip_{y}=abs(lhip_{y}−rhip_{y}). lhip_{y} is the y-coordinate of the left hip, and rhip_{y} is the y-coordinate of the right hip.

When the keypoint is not detected, it is filtered because the coordinates come out (0, 0).

The person search apparatus 100 can calculate the x-coordinate distance of both shoulders (operation S610).

The person search apparatus 100 can determine whether the x-coordinate of the left shoulder or the x-coordinate of the right shoulder is 0 (operation S620).

When the x-coordinate of the left shoulder or the x-coordinate of the right shoulder is 0, the person search apparatus 100 can determine the x-coordinate distance between both shoulders as 0 (operation S621).

When the x-coordinate of the left shoulder and the x-coordinate of the right shoulder are not 0, the person search apparatus 100 can determine whether the x-coordinate of the left hip or the x-coordinate of the right hip is 0 (operation S630).

When the x-coordinate of the left hip or the x-coordinate of the right hip is 0, the person search apparatus 100 determines that the x-coordinate distance between the two hips is 0 (operation S631).

When the x-coordinate of the left hip and the x-coordinate of the right hip are not 0, the person search apparatus 100 can determine whether any one of the x-coordinate of the left shoulder, the x-coordinate of the right shoulder, the x-coordinate of the left hip, or the x-coordinate of the right hip is 0 (operation S640).

When none of them is 0, the person search apparatus 100 can calculate an upper body size score through Equation 4 (operation S650).

$$\frac{100 * \{ \frac{{shld}_{x} + {hip}_{x}}{{f}_{w}} + ( \frac{{body}_{h}}{{f}_{h}} ) \}}{3} \qquad [ Equation4 ]$$

Here, bodyₕ is the height of the upper body of the person, shldₓ is the x-coordinate distance between both shoulders, hipₓ is the x-coordinate distance between both hips, and f_{w} is the width of the entire frame.

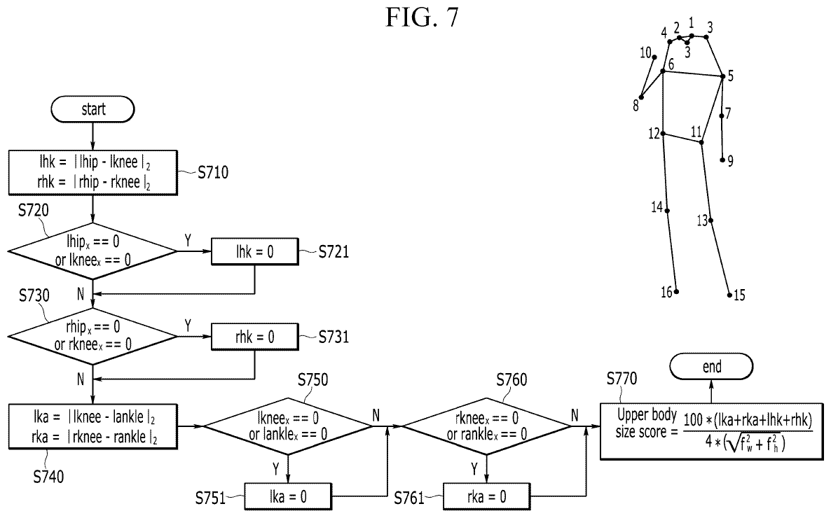

FIG. 7 is a flowchart of an example of a lower body size score calculation algorithm.

The person search apparatus 100 can calculate a lower body size score based on a key point-based knee-to-ankle coordinate distance and a key point-based hip-to-knee coordinate distance.

In FIG. 7, lka is L2 Norm from the left knee to the left ankle, and lka=|lknee−rankle|₂. lknee is the key point number 13, and lankle is the key point number 15.

rka is L2 Norm from the right knee to the right ankle, and rka=lrknee−rankle|₂. rknee is the keypoint number 14, and rankle is the keypoint number 16.

lhk is L2 Norm from left hip to the left knee, and lhk=|lhip−lknee|₂. lhip is keypoint number 11.

rhk is L2 Norm from the right hip to the right knee, and rhk=|rhip−rknee|₂. rhip is the keypoint number 12.

When the keypoint is not detected, it is filtered because the coordinates come out (0,0).

The person search apparatus 100 can calculate lhk and rhk (operation S710).

The person search apparatus 100 determines whether lhip or lknee is 0 (operation S720).

When lhip or lknee is 0, the person search apparatus 100 can determine lhk as 0 (operation S721).

Otherwise, the person search apparatus 100 can determine whether rhipₓ or rkneeₓ is 0 (operation S730).

When rhipₓ or rkneeₓ is 0, the person search apparatus 100 can determine rhk as 0 (operation S731).

Otherwise, the person search apparatus 100 can calculate lka and rka (operation S740).

The person search apparatus 100 determines whether lkneeₓ or lankleₓ is 0 (operation S750).

When lkneeₓ or lankleₓ is 0, the person search apparatus 100 determines lka to be 0 (operation S751).

Otherwise, the person search apparatus 100 can determine whether rkneeₓ or rankleₓ is 0 (operation S760).

When rkneeₓ or rankleₓ is 0, the person search apparatus 100 determines rka to be 0 (operation S761).

Otherwise, the person search apparatus 100 can calculate a lower body size score using Equation 5.

$$\frac{100 * ( lka + rka + lhk + rhk )}{4 * ( \sqrt{{f}_{w}^{2} + {f}_{h}^{2}} )} \qquad [ Equation5 ]$$

Here, lka is L2 Norm from the left knee to the left ankle, rka is L2 Norm from the right knee to the right ankle, lhk is L2 Norm from the left hip to the left knee, rhk is L2 Norm from the right hip to the right knee, f_{w} is the width of the entire frame, and fₕ is the height of the entire frame.

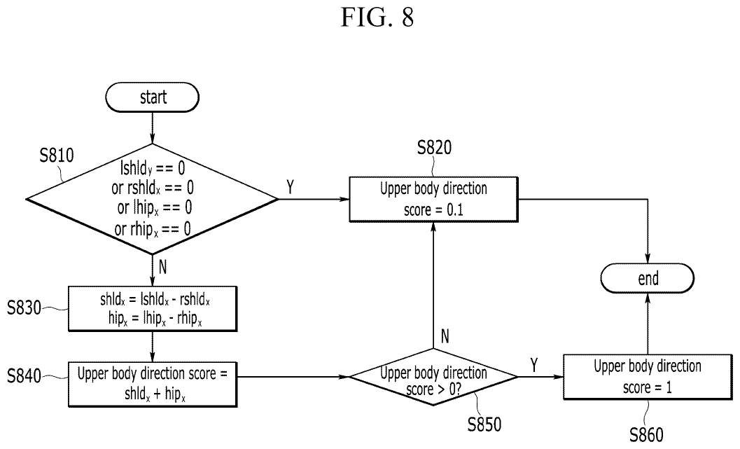

FIG. 8 is a flowchart of an example of an upper body direction score calculation algorithm.

In FIG. 8, when the upper body direction is not the direction of the front, the person search apparatus 100 can determine a score greater than 0 and less than 1 as an upper body direction score.

For example, when the direction of the human body is not the direction of the front, the person search apparatus 100 can give 0.1 to determine the person keyshot score to be smaller than that of the case where the direction of the human body is the direction of the front.

The person search apparatus 100 can determine whether lshldₓ, rshldₓ, lhipₓ, or rhipₓ is 0 (operation S810).

When lshldₓ, rshldₓ, lhipₓ, or rhipₓ is 0, the person search apparatus 100 can determine the upper body direction score as 0.1 (operation S820).

When lshldₓ, rshldₓ, lhipₓ, or rhipₓ are not 0, the person search apparatus 100 can calculate shldₓ and hipₓ (operation S830).

The person search apparatus 100 can determine an upper body direction score by summing shldₓ and hipₓ (operation S840). shldₓ is an x-coordinate distance between both shoulders, and hipₓ is an x-coordinate distance between both hips.

The person search apparatus 100 can determine whether the upper body direction score is greater than 0 (operation S850).

The person search apparatus 100 can determine the upper body direction score as 0.1 when the upper body direction score is less than or equal to 0.

The person search apparatus 100 can determine the upper body direction score as 1 when the upper body direction score is greater than 0 (operation S860).

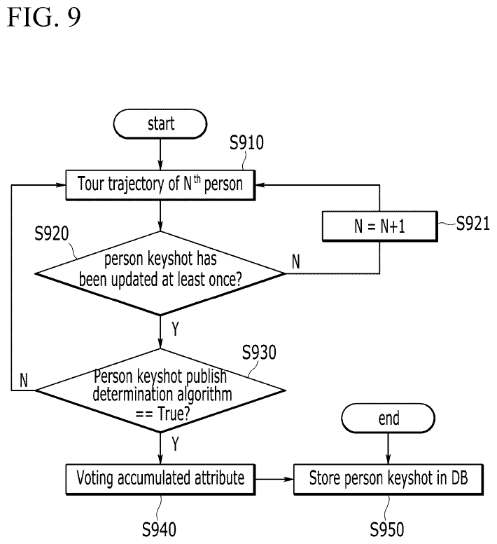

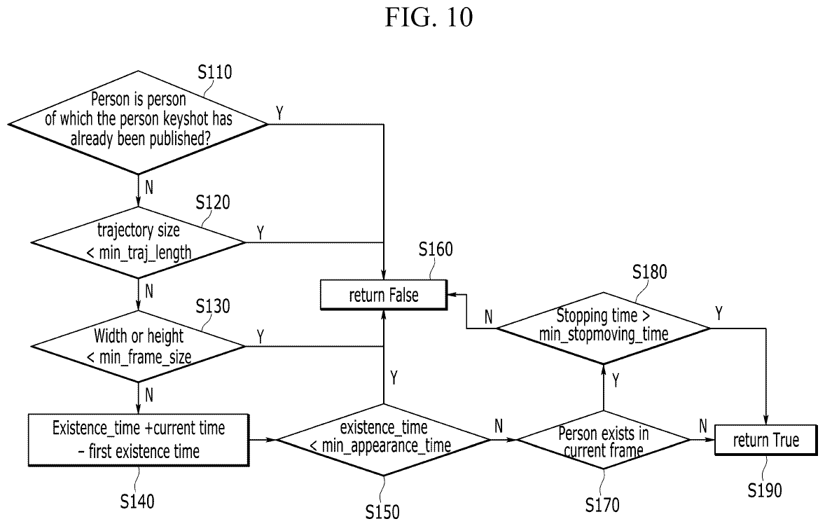

FIGS. 9 and 10 are flowcharts of a person keyshot storage algorithm.

FIG. 9 illustrates an example of a person keyshot storage algorithm, and FIG. 10 illustrates an example of a person keyshot publish determination algorithm.

In FIG. 9, the person search apparatus 100 can tour the trajectory of the N^{th} person (operation S910).

The person search apparatus 100 can determine whether the person keyshot has been updated at least once (operation S920).

When the person keyshot has not been updated at least once, the person search apparatus 100 tours the trajectory with respect to the N+1^{th} person (operation S921).

When the person keyshot has been updated at least once, the person search apparatus 100 can determine whether the person keyshot publish determination algorithm outputs True (operation S930).

When the person keyshot publish determination algorithm outputs True, the person search apparatus 100 can vote the accumulated attributes (operation S940).

The person search apparatus 100 can store a person keyshot in a database (operation S950).

In FIG. 10, the minimum trajectory length (min_traj_length), the minimum appearance time (min_appearance_time), the minimum stop time (min_stopmoving_time), and the minimum frame size (min_frame_size) for the algorithm can be predetermined.

For example, the minimum trajectory length (min_traj_length) can be 10, the minimum appearance time (min_appearance_time) can be 2, the minimum stop time (min_stopmoving_time) can be 10, and the minimum frame size (min_frame_size) can be 30.

The person search apparatus 100 can determine whether to store the person keyshot in the database by considering at least one of the frame size, presence time, and presence of the current person keyshot in the current camera frame with respect to the updated current person keyshot.

The person search apparatus 100 can determine whether a person is the person of which the person keyshot has already been published (operation S110).

The person search apparatus 100 can output False when the person keyshot of the corresponding person has already been published before (operation S160).

The person search apparatus 100 can determine whether the length of the person's trajectory is less than the minimum trajectory length when the person keyshot has not already been published before (operation S120).

When the length of the person's trajectory is less than the minimum trajectory length, the person search apparatus 100 can output False (operation S160).

When the length of the human trajectory is greater than or equal to the minimum trajectory length, the person search apparatus 100 can determine whether the size including the width or height of the person keyshot is less than the minimum frame size (operation S130).

When the size of the person keyshot is smaller than the minimum frame size, the person search apparatus 100 can output False (operation S160).

When the size of the person keyshot is greater than or equal to the minimum frame size, the person search apparatus 100 can calculate the existence time of a person by subtracting the first existence time from the current time (operation S140).

The person search apparatus 100 can determine whether the existence time of the person is less than the minimum appearance time (operation S150). When the existence time of the person is less than the minimum appearance time, the person search apparatus 100 outputs False (operation S160).

When the existence time of the person is greater than or equal to the minimum appearance time, the person search apparatus 100 can determine whether a person exists in the current frame (operation S170).

The person search apparatus 100 can output True when a person does not exist in the current frame (operation S190).

When a person exists in the current frame, the person search apparatus 100 can determine whether the person's stopping time is greater than the minimum stopping time (operation S180).

The person search apparatus 100 can output True when the person's stopping time is greater than the minimum stopping time (operation S190).

The person search apparatus 100 can output False when the stopping time of the person is less than or equal to the minimum stopping time (operation S160).

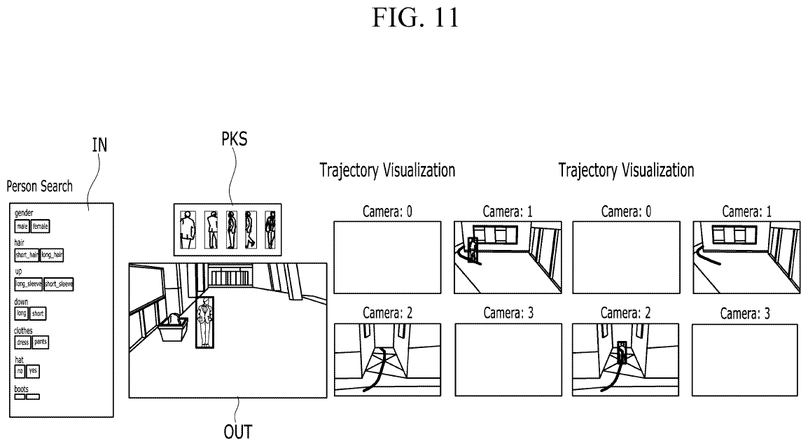

FIG. 11 is a diagram illustrating an example of a person search result.

In FIG. 11, a user can input an attribute of a person through an attribute input interface IN provided for a person search.

When the attribute is input, the person search apparatus 100 can output a person keyshot PKS corresponding to the attribute.

When the user selects the output person keyshot PKS, the person search apparatus 100 can output an image OUT of a person for a specific time before and after the frame in which the person keyshot PKS is stored.

The person search apparatus 100 can output a trajectory of a person in a multi-camera (trajectory visualization).

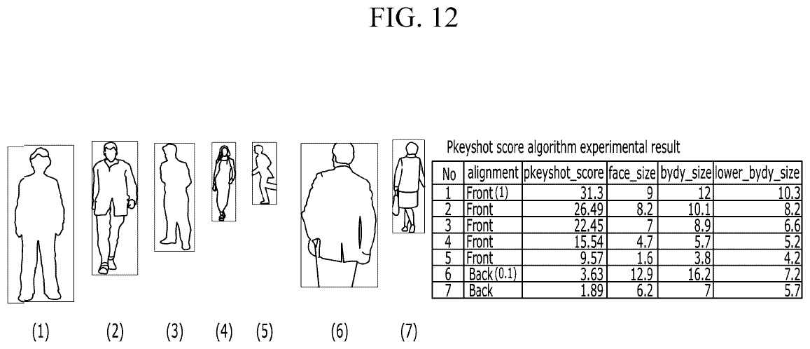

FIG. 12 is a diagram illustrating an example of a person keyshot and a person keyshot score.

FIG. 12 shows a table showing 7 person keyshots and an upper body direction score, a person keyshot score, a face size score, an upper body size score, and a lower body size score for the 7 person keyshots.

In FIG. 12, for person keyshot No. 1 to person keyshot No. 5, the upper body direction score can be calculated as 1 (front).

For person keyshot No. 6 and person keyshot No. 7, the upper body direction score can be calculated as 0.1 (back).

For example, a person keyshot score of person keyshot No. 1 can be about 31.3, and this can be calculated as 1*(9+12+10.3) according to Equation 1 described above. Any coefficient can be 1.

For example, person keyshot score of No. 6 is about 3.63, which can be calculated as 0.1*(12.9+16.2+7.2).

FIG. 13 is a diagram illustrating an example of a computing device.

Referring to FIG. 13, the person search apparatus and method according to the implementations can be implemented by using a computing device 900.

The computing device 900 can include at least one of a processor 910, a memory 930, a user interface input device 940, a user interface output device 950, and a storage device 560 communicating via a bus 920. The computing device 900 can also include a network interface 970 that is electrically connected to a network 90. The network interface 970 can transmit or receive a signal with another entity through the network 40.

The processor 910 can be implemented in various types, such as a Micro Controller Unit (MCU), an Application Processor (AP), a Central Processing Unit (CPU), a Graphic Processing Unit (GPU), a Neural Processing Unit (MPU), and the like, and can be a predetermined semiconductor device executing commands stored in the memory 930 or the storage device 960. The processor 910 can be configured to implement the functions and the methods described above with reference to FIGS. 1 to 12.

The memory 930 and the storage device 960 can include various forms of volatile or non-volatile storage media. For example, the memory can include a Read Only Memory (ROM) 931 and a Random Access Memory (RAM) 932. In some implementations, the memory 930 can be located inside or outside the processor 910, and the memory 930 can be connected with the processor 910 through already known various means.

In some implementations, at least some configurations or functions of the person search apparatus and method according to the implementations can be implemented as programs or software executed on the computing device 900, and the programs or software can be stored on a computer-readable medium.

In some implementations, at least some configurations or features of the person search apparatus and method according to the implementations can be implemented using hardware or circuit of the computing device 900, or can be implemented as separate hardware or circuit that can be electrically connected to computing device 900.

Although the above implementations of the present disclosure have been described in detail, the scope of the present disclosure is not limited thereto, but also includes various modifications and improvements by one of ordinary skill in the art utilizing the basic concepts of the present disclosure as defined in the following claims.

What is claimed is:

1. A person search apparatus configured to search for a person and a trajectory of the person based on appearance information of the person acquired through one or more cameras, the person search apparatus comprising:
one or more processors; and
one or more memory devices storing a program code configured to, based on being executed by the one or more processors, cause the person search apparatus to perform operations comprising:
based on an input of an image of a human acquired from the one or more cameras, outputting recognition information including an attribute of the human,
storing, in a database, the recognition information and a person keyshot that is generated based on the recognition information, and
in response to a request of a user, searching for a target person based on attribute information of the human and re-identification information in the database.

2. The person search apparatus of claim 1, wherein outputting the recognition information comprises:
inferring, by using an artificial intelligence model, the recognition information including at least one of a skeleton, a bounding box, a keypoint, a pose, an action, or an attribute of the human in the image.

3. The person search apparatus of claim 2, wherein storing the recognition information and the person keyshot comprises:
accumulating and storing the recognition information in the database;
calculating a face size score, an upper body size score, a lower body size score, and an upper body direction score;
calculating a person keyshot score based on the face size score, the upper body size score, the lower body size score, and the upper body direction score; and
updating a current person keyshot based on the recognition information and the person keyshot score.

4. The person search apparatus of claim 3, wherein storing the recognition information and the person keyshot further comprises:
determining whether to store the updated current person keyshot in the database based on at least one of a frame size of the current person keyshot, a presence time of the current person keyshot, or whether the current person keyshot is present in a current camera frame.

5. The person search apparatus of claim 3, wherein calculating the face size score, the upper body size score, the lower body size score, and the upper body direction score comprises:
calculating the face size score based on a coordinate distance between eyes of the human and a coordinate distance between ears of the human;
calculating the upper body size score based on a coordinate distance between shoulders of the human and a coordinate distance between hips of the human; and
calculating the lower body size score based on a keypoint-based knee-to-ankle coordinate distance of the human and a keypoint-based hip-to-knee coordinate distance of the human.

6. The person search apparatus of claim 3, wherein calculating the person keyshot score comprises:
calculating the person keyshot score through Equation 1,
Person keyshot score=Upper body direction score*(α*face size score+β*upper body size score+γ*lower body size score), Equation 1
here, α, β, and γ are arbitrary coefficients.

7. The person search apparatus of claim 6, wherein calculating the person keyshot score through the Equation 1 comprises:
based on an upper body direction of the human not being oriented to a front of the human, determining the upper body direction score from an arbitrary score between 0 and 1.

8. The person search apparatus of claim 1, wherein searching for the target person comprises:
outputting a target person keyshot for the target person from the database based on the attribute information including at least one attribute selected by the user.

9. The person search apparatus of claim 8, wherein searching for the target person further comprises:
based on the user selecting the target person keyshot that is output from the database, outputting one or more images stored during a pried including a time point at which the target person keyshot is stored.

10. The person search apparatus of claim 9, wherein searching for the target person further comprises:
outputting a trajectory of the target person within a range of the one or more cameras through the re-identification information based on the target person keyshot.

11. A person search method performed by a computing device including a processor and a memory, the person search method comprising:
based on an input of an image of a human acquired from the one or more cameras, outputting recognition information including an attribute of the human;
storing, in a database, the recognition information and a person keyshot that is generated based on the recognition information; and
in response to a request of a user, searching for a target person based on attribute information of the human and re-identification information in the database.

12. The person search method of claim 11, wherein outputting the recognition information comprises:
inferring, by using an artificial intelligence model, the recognition information including at least one of a skeleton, a bounding box, a keypoint, a pose, an action, or an attribute of the human in the image.

13. The person search method of claim 12, wherein storing the recognition information and the person keyshot comprises:
accumulating and storing the recognition information in the database;
calculating a face size score, an upper body size score, a lower body size score, and an upper body direction score;
calculating a person keyshot score based on the face size score, the upper body size score, the lower body size score, and the upper body direction score; and
updating a current person keyshot based on the recognition information and the person keyshot score.

14. The person search method of claim 13, wherein storing the recognition information and the person keyshot further comprises:
determining whether to store the updated current person keyshot in the database based on at least one of a frame size of the current person keyshot, a presence time of the current person keyshot, or whether the current person keyshot is present in a current camera frame.

15. The person search method of claim 13, wherein calculating the face size score, the upper body size score, the lower body size score, and the upper body direction score comprises:
calculating the face size score based on a coordinate distance between eyes of the human and a coordinate distance between ears of the human;
calculating the upper body size score based on a coordinate distance between shoulders of the human and a coordinate distance between hips of the human; and
calculating the lower body size score based on a keypoint-based knee-to-ankle coordinate distance of the human and a keypoint-based hip-to-knee coordinate distance of the human.

16. The person search method of claim 13, wherein calculating the person keyshot score comprises:
calculating the person keyshot score through Equation 1,
Person keyshot score=Upper body direction score*(α*face size score+β*upper body size score+γ*lower body size score), Equation 1
here, α, β, and γ are arbitrary coefficients.

17. The person search method of claim 16, wherein calculating the person keyshot score through the Equation 1 comprises:
based on an upper body direction of the human not being oriented to a front of the human, determining the upper body direction score from an arbitrary score between 0 and 1.

18. The person search method of claim 11, wherein searching for the target person comprises:
outputting a target person keyshot for the target person from the database based on the attribute information including at least one attribute selected by the user.

19. The person search method of claim 18, wherein searching for the target person further comprises:
based on the user selecting the target person keyshot that is output from the database, outputting one or more images stored during a pried including a time point at which the target person keyshot is stored.

20. The person search method of claim 19, wherein searching for the target person further comprises:
outputting a trajectory of the target person within a range of the one or more cameras through the re-identification information based on the target person keyshot.
